(19) United States
(12) Patent Application Publication
(10) Pub. No.: US 2006/0163351 A1
(43) Pub. Date: Jul. 27, 2006

(54) Reader and/or writer for radio frequency ID tag

(76) Inventors: Shoji Kuriki, Kanagawa (JP); Tatsuya Fujii, Hyogo (JP); Shinji Yoshioka, Osaka (JP)

Correspondence Address: DICKSTEIN SHAPIRO MORIN & OSHINSKY LLP, 2101 L Street, NW, Washington, DC, 20037, US

(21) Appl. No.: 11/304,592

(22) Filed: Dec. 16, 2005

(30) Foreign Application Priority Data
Dec. 17, 2004 (JP) 2004-366280

(51) Int. Cl. G06K 7/00; G08B 13/14; H04Q 5/22

(52) U.S. Cl. 235/439; 340/572.7; 340/10.1

(57) ABSTRACT

An ID tag reader/writer for writing and reading data in and from one or more ID tags is provided. The ID tag reader/writer includes (a) one or more antennas configured to perform radio communications with the ID tags, (b) one or more analog frontend units, each unit being provided for one of the antennas, configured to generate a carrier wave based on a clock signal and to perform signal modulation and demodulation, and (c) a controller configured to generate and output the clock signal to the analog frontend units and select one of the analog frontend units corresponding to a target ID tag to which data are to be transmitted, wherein the controller performs data transmission to and from the analog frontend units using digital signals.

### BACKGROUND OF THE INVENTION

1. Field of the Invention

The present invention generally relates to an ID tag reader/writer for reading and/or writing information from and/or in a radio frequency ID tag, and more particularly, to an ID tag reader/writer capable of performing data transmission to and from multiple types of ID tags with satisfactory communications quality.

2. Description of Related Art

In recent years and continuing, device management systems or inventory management systems using radio frequency ID tags attached to devices or products have been put into practical use. In such systems, information about each device or product is stored in the ID tag, and the ID information items are acquired from the ID tags via wireless transmission to manage the devices or the products. For example, various types of parts and accessories, such as different sizes of paper cassettes or different colors of toner cartridges, are fit into the main frame of an apparatus, such as a printer or a photocopier. To allow an apparatus of a particular model to work correctly, each part or item attached to the apparatus must be a correct one suitable to that model. To check whether correct parts and accessories are used in the apparatus, information about each part or accessory has to be confirmed. To facilitate this task, an ID tag is attached to each of the items, and an ID tag reader/writer is used to read the information from the respective items.

In general, information has to be read from all the ID tags on the parts or items located in various positions of the apparatus using a single reader/writer. Several techniques for performing data transmission to and from multiple ID tags using a single reader/writer are known. One method is to provide a single antenna on the reader/writer and to perform radio communication with all the ID tags using the single antenna. Because collision avoidance is required in this method, anti-collision processing becomes indispensable, which processing is carried out generally by allocating an ID code to each of the ID tags and selecting a specific ID code for the desired data transmission. This method is effective as long as all the tags are arranged in close formation. However, the ID tags attached to the parts and the accessories of a photocopier or a printer are located at various positions away from each in or on the main body. For this reason, the output power level of the antenna has to be increased to guarantee radio communications with all the ID tags. In addition, depending on the parts or accessories, they may be surrounded by metal pieces, or located at a position where it is hard to receive radio waves from the antenna of the reader/writer.

Another method is to provide multiple antennas to a reader/writer and selectively activate one of the antennas using a switch to carry out radio communications with those ID tags located near the selected antenna. For example, JP 10-21351 A discloses an ID tag reader/writer illustrated in FIG. 1A and FIG. 1B. In this publication, a reader/writer 109 with multiple antennas 103 arranged in a matrix is placed under a conveyer belt 113, and a tray 111 carrying dishes 112 moves on the conveyer belt 113. An ID tag 110 is attached to each of the dishes 112. Each of the antennas 103 is connected to one of the signal lines extending from a progressive line scan circuit 107 and one of the signal lines extending from a progressive column scan circuit 108. As the tray 111 moves, the antennas 103 are successively activated to detect the ID code of the ID tags attached to dishes 112 on the tray 111 at positions corresponding to the associated antennas 103. Since each of the antennas 103 has a certain effective communication range, the dishes 112 with the ID tags 110 are placed on the tray 111 at intervals greater than or substantially equal to the effective communication range of the antenna 103 to allow the system to identify each of the ID tags independently using a single carrier frequency.

Another publication, JP 2000-341170 A discloses a file management system using RF-IDs. In this publication, an antenna switching unit is inserted between an antenna activation circuit and multiple antennas so as to successively select one of the antennas.

However, the first method for performing radio communications with all the ID tags using a single antenna of the reader/writer is inferior in communication efficiency because a large antenna output is required. This method is unsuitable for application to part/accessory management of a photocopier or a printer because radio waves may not reach some ID tags surrounded by metal pieces.

With the second method using multiple antennas, if two or more ID tags exist within the communication range of a certain antenna, anti-collision processing has to be performed. To avoid this inconvenience, the ID tags have to be arranged such that a single ID tag is located in each of the communication ranges of the antennas. When applying this method to part/accessory management of a photocopier or a printer, anti-collision processing becomes indispensable because the parts and the accessories with ID tags are often located close to each other.

In general, high-frequency analog signals propagate through signal lines between the antenna and the main unit of the reader/writer. As the radio frequency used between the antenna and an ID tag becomes higher, the acceptable distance from the antenna to the main unit of the reader/writer is constrained due to signal attenuation and/or noise emission. This means that guaranteeing a sufficient distance between the main unit of the reader/writer and the antenna becomes difficult. However, inside a photocopier or a printer, the antennas have to be placed away from the main unit of the reader/writer because parts and accessories with ID tags are located at various positions. In this case, communication quality is degraded greatly due to excessive length of high-frequency signal lines between the antenna and the main unit of the reader/writer.

### SUMMARY OF THE INVENTION

The present invention was conceived in view of the above-described problems, and it is an object of the invention to provide an ID tag reader/writer that can guarantee a sufficient distance between the antenna part and the main unit of the reader/writer and can read information from all the ID tags without increasing the antenna output level.

It is another object of the invention to provide an ID tag reader that can appropriately communicate with a specific ID tag even if two or more ID tags exist within the communication range of an antenna.

To achieve the objects, an ID tag reader/writer for writing and reading data in and from one or more ID tags is provided. The ID tag reader/writer includes:

one or more antennas configured to perform radio communication with the ID tags;

one or more analog frontend units, each unit being provided corresponding to one of the antennas, configured to generate a carrier wave based on a clock signal and perform signal modulation and demodulation; and

a controller configured to generate and output the clock signal to the analog frontend units and select one of the analog frontend units corresponding to a target ID tag to which data are to be transmitted; wherein the controller performs data transmission to and from the analog frontend units using digital signal lines.

### BRIEF DESCRIPTION OF THE DRAWINGS

Other objects, features, and advantages of the invention will become more apparent from the following detailed description when read in conjunction with the accompanying drawings, in which:

FIG. 1A and FIG. 1B illustrate a prior art ID tag reader/writer with multiple antennas;

FIG. 2 is a schematic block diagram of an ID tag reader/writer according to the an embodiment of the invention;

FIG. 3 is a schematic diagram illustrating the address setting unit shown in FIG. 2;

FIG. 4 is a schematic block diagram of the transmission clock generator shown in FIG. 2;

FIG. 5 is a schematic diagram illustrating an example of the format of data transmitted from the controller 2 to analog frontend units FE1-Fen;

FIG. 6 is a table illustrating types of commands contained in the data stream shown in FIG. 5; and

FIG. 7 is a flowchart showing the operations of the AFE control circuit.

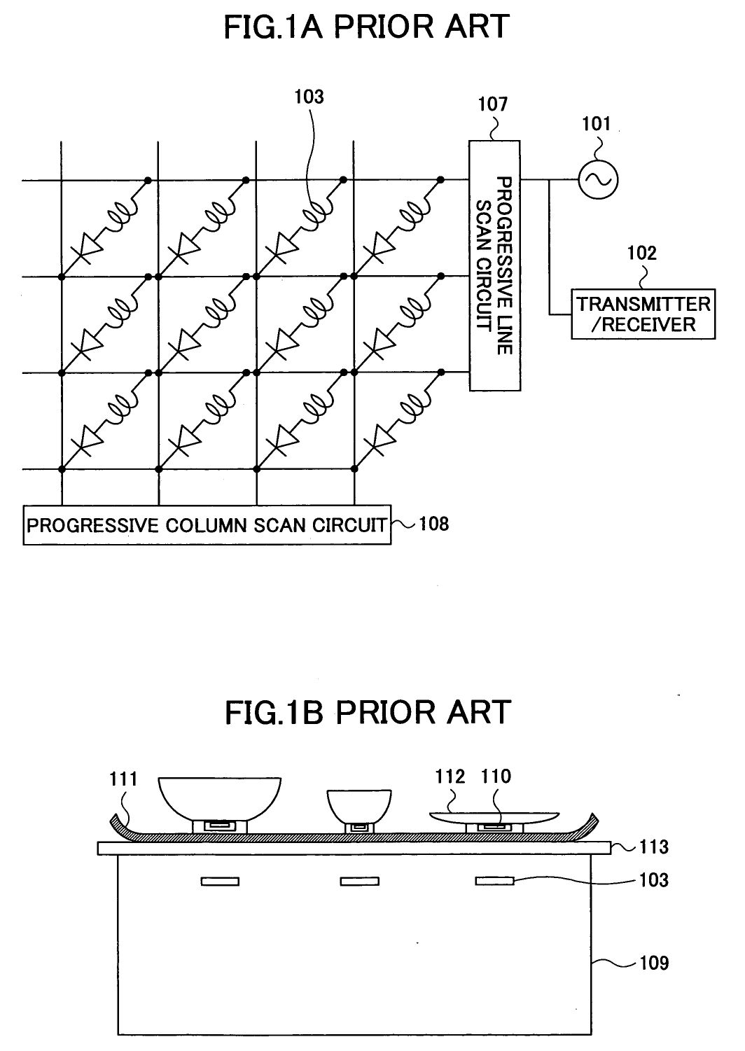

### DETAINED DESCRIPTION OF THE PREFERRED EMBODIMENTS

The preferred embodiments of the present invention are described below, in conjunction with the attached drawings.

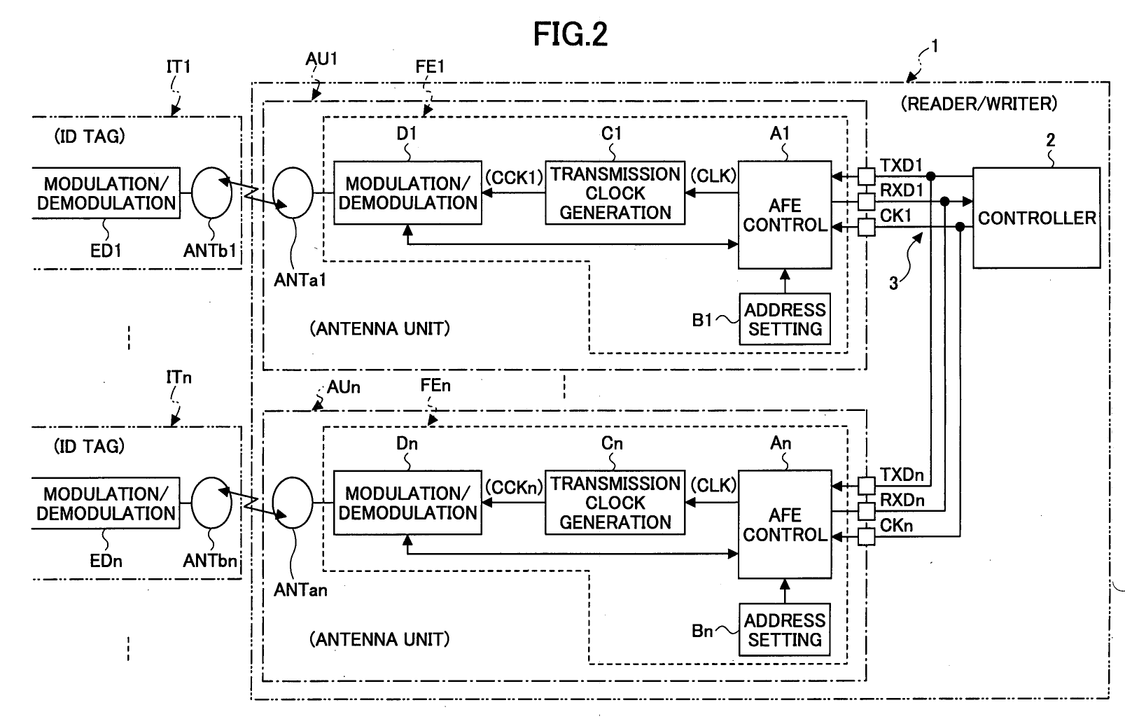

FIG. 2 is a schematic block diagram illustrating an example of an ID tag reader/writer according to an embodiment of the invention. The ID tag reader/writer (hereinafter, referred to simply as “reader/writer”) 1 has a controller 2, analog frontend units FE1-FEn (where n is an integer greater than zero (n>0)) connected to the controller 2 via a transmission path 3, and multiple antennas ANTa1-ANTan connected to the associated analog frontend units FE1-Fen. The controller 2 generates and outputs a clock signal CLK of a prescribed frequency, and outputs data to be transmitted. The received data are also input to the controller 2.

The controller 2 may be structured as a single chip or multiple integrated circuits. Each of the analog frontend units FE1-FEn and the associated one of the antennas ANTa1-ANTan define one of antenna units AU1-AUn. The analog frontend units FE1-FEn have the same structure, and the antenna units AU1-AUn also have the same structure. Accordingly, explanation is made of an arbitrary antenna unit AUm (m is an arbitrary number in the range from 1 to n) below.

The antenna unit AUm has a data input terminal TXDm through which data to be transmitted are supplied to the antenna unit AUm, a data output terminal RXDm through which received data are output from the antenna unit AUm to the controller 2, and a clock input terminal CKm through which a clock signal is supplied to the antenna unit AUm. The input terminal TXDm is connected to the data output terminal of the controller 2 via a corresponding serial signal line of the transmission path 3, the data output terminal RXDm is connected to the data input terminal of the controller 2 via a corresponding serial signal line of the transmission path 3, and the clock input terminal CKm is connected to the clock output terminal of the controller 2 via a corresponding serial signal line of the transmission path 3.

The analog frontend unit FEm includes an AFE control circuit Am, an address setting unit Bm, a transmission clock generator Cm, and a modulator/demodulator Dm. The AFE control circuit Am transmits and receives data to and from the controller 2 via the transmission path 3. To be more precise, the AFE control circuit Am analyzes the data supplied from the controller 2 to control the respective parts of the analog frontend unit Fem, and outputs the clock signal CLK supplied from the controller 2 to the transmission clock generator Cm.

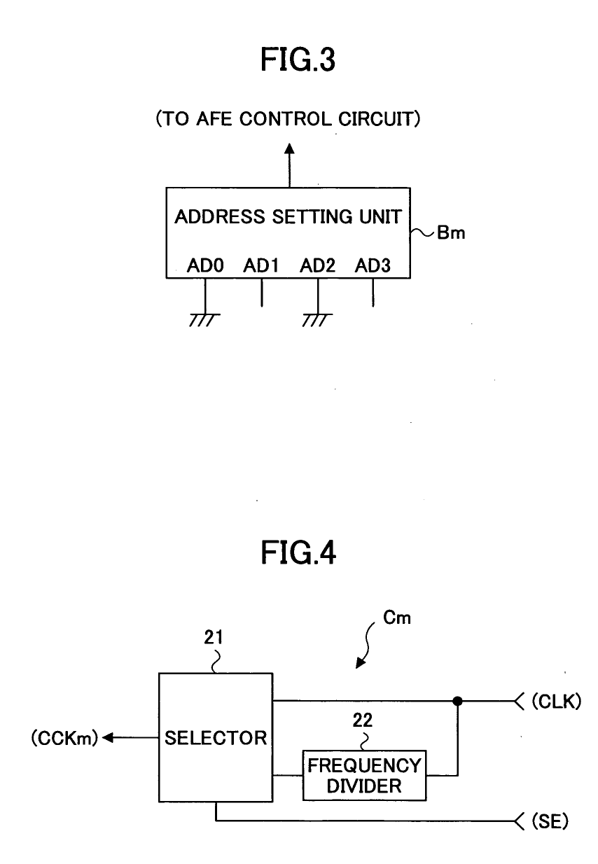

The address setting unit Bm has multiple address setting terminals. For example, if the number “n” of the antenna units AU1-AUn is 16 (n=16), the address setting unit Bm has four terminals AS0-AD3, as illustrated in FIG. 3, to designate an address by the binary levels of the respective terminals. In the example shown in FIG. 3, terminals AD0 and AD2 are grounded, while terminals AD1 and AD3 are at a high level in the disconnected state. In this case, address “0101” (corresponding to decimal number 9) is designated. The designated address is supplied to the AFE control circuit Am. In FIG. 3, sixteen (16) 4-bit addresses can be designated. The number of terminals of the address setting unit Bm can be adjusted according to the number of ID tags that the reader/writer is going to communication with.

The transmission clock generator Cm generates carrier waves with different frequencies based on the clock signal CLK supplied from the AFE control circuit Am, and selects a carrier wave in accordance with the control signal supplied from the AFE control circuit Am. The transmission clock generator Cm includes a selector 21 and a frequency divider 22, as illustrated in FIG. 4. The selector 21 has multiple inputs including the clock signal CLK supplied from the AFE control circuit Am and one or more lower-frequency signals obtained by dividing the clock signal CLk at the frequency divider 22. (In this example, only a frequency-divided signal is input to the selector 21). The selector 21 selects one of the frequencies from the input clocks according to the frequency selection control signal SE supplied from the AFE control circuit Am. The signal with the selected frequency is output as a transmission clock signal CCKm to the modulator/demodulator Dm.

The modulator/demodulator Dm modulates the data signal supplied from the AFE control circuit Am and the transmission clock signal CCKm supplied from the transmission clock generator Cm, which clock signal functions as a carrier wave, using a prescribed modulation scheme, and outputs the modulated signal to the antenna ANTam. The modulator/demodulator Dm also demodulates the received signal supplied from the antenna ANTam using a prescribed demodulation scheme, and supplies the demodulated data to the AFE control circuit Am. The AFE control circuit Am supplies the data signal from the modulator/demodulator Dm to the controller 2 via the transmission path 3.

The antenna ANTam and the analog frontend unit Fem are arranged in close formation to shorten the wiring length between the antenna ANTam and the analog frontend unit Fem for the purpose of reducing signal attenuation and noise emission. On the other hand, the controller 2 is arranged separate from the antenna units AU1-AUn, and digital data transmission is performed between the controller 2 and each of the antenna frontend units FE1-FEm.

The reader/writer 1 has antenna units AU as many as the number of ID tags to be monitored by the reader/writer 1. The antenna units AU1-AUn of the reader/writer 1 are placed near the ID tags IT1-ITn in the example shown in FIG. 2. Since the ID tags IT1-ITn have the same structure, explanation is made of an arbitrary ID tag ITm below.

The ID tag ITm includes an antenna ANTbm and a modulator/demodulator EDm connected to the antenna ANTbm. The internal structure and the operation of the ID tag ITm are known, and therefore, detailed explanation for them is omitted here.

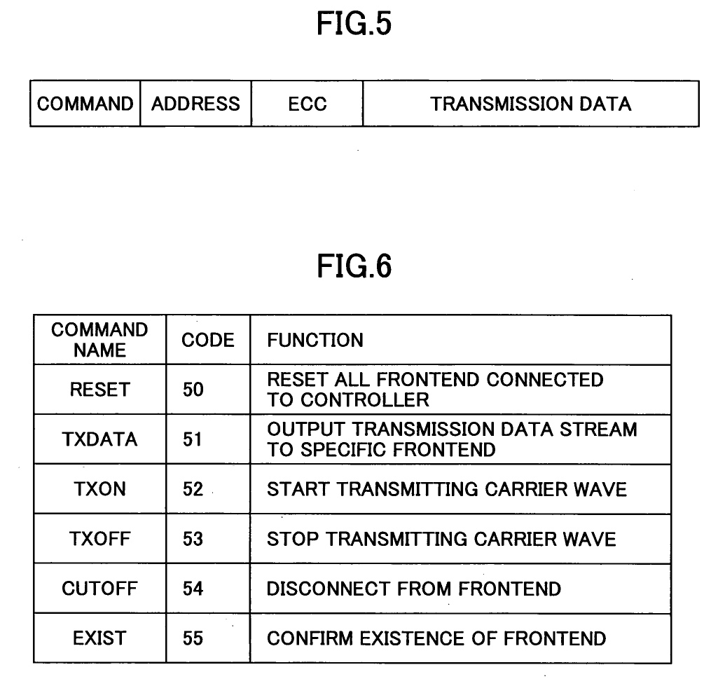

FIG. 5 illustrates an example of the data format of data stream supplied from the controller 2 to the respective analog frontend units FE1-Fen. The data format includes a command field, an address field, an ECC data field, and a transmission data field from the head.

The command field is an 8-bit field, and various commands illustrated in FIG. 6 can be stored in the command field. The address field is an 8-bit field, which field is used to designate a desired analog frontend unit among the analog frontend units FE1-FEn connected to the controller 2. The ECC data field is a 16-bit field used to confirm whether the command data and the address data have been correctly received. For example, the ECC data have a data structure of inverted sequences of the command code and the address code to invert the logic. The transmission data field stores information to be transmitted to the ID tag.

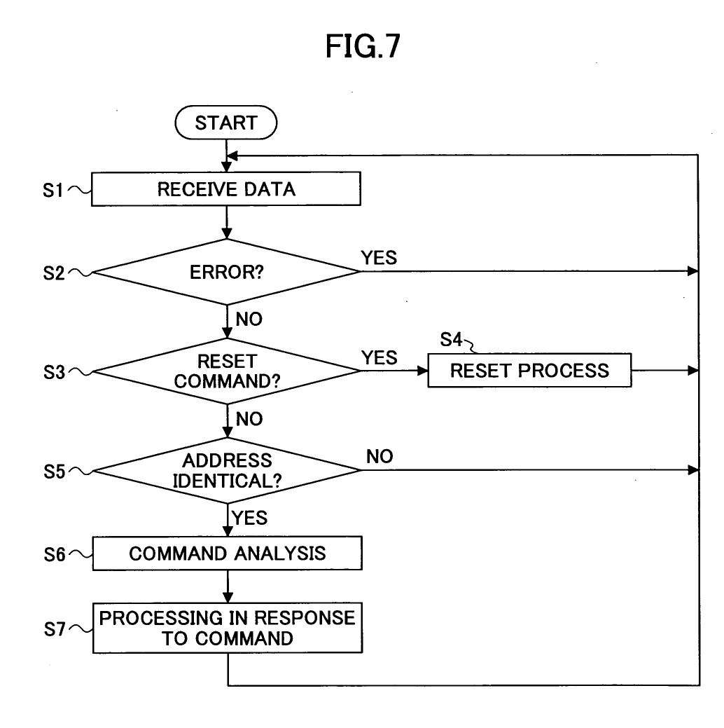

FIG. 7 is a flowchart showing the operations of the analog frontend unit FEm. The AFE control circuit Am of the analog frontend unit FEm receives data from the controller 2 (step S1), and performs an error check using the ECC data to determine whether there is an error in the command and the address (step S2). If there is an error (YES in S2), the process returns to step S1 without processing the currently received data and receives the data from the controller 2 again. If there is no error (NO in S2), the AFE control circuit Am determined whether the command is a RESET command (step S3). If the input command is a RESET command (YES in S3), the AFE control circuit Am resets all the circuits in the analog frontend unit FEm (Step S4). Then, the process returns to step S1. The RESET command is used in common for all the analog frontend units, and therefore, the address field shown in FIG. 5 may be omitted.

If the command is not a RESET command (NO in S3), the AFE control circuit Am performs an address check to determine whether the received address data agree with the address designated by the address setting unit Bm (step S5). If the received address data do not agree with the designated address (NO in S5), the process returns to step S1. If the received address data agree with the address designated by the address setting unit Bm (YES in S5), the AFE control circuit Am analyzes the command (step S6), and performs the process according to the command (step S7). Then, the process returns to step S1.

In this manner, the controller 2 selects an analog frontend unit that can communicate with a target ID tag from which information is to be collected.

If there are two or more ID tags existing in the transmission range of a single antenna unit, the carrier frequency used for communication with the ID tags is changed at the transmission clock generator Cm based on the frequency selection control signal SE in order to avoid collisions. Although in FIG. 4 a carrier is selected from only two carrier waves, further frequency dividers with different ratios may be added to increase the available carrier waves so as to deal with three or more ID tags located in the same transmission range.

Preferably, the circuits included in the analog frontend unit FEm are integrated in a single chip to form an IC. Since the structures of the analog frontend units FE1-FEn are the same, a mass-production effect can be obtained when using many analog frontend units in a signal reader/writer, and the manufacturing cost can be reduced. Such an IC includes all the circuit treating analog signals transmitted to and received from the corresponding one of the antennas ANTa1-ANTan. Accordingly, by arranging the frontend IC and the associated antenna ANT in close formation, the path length between the frontend unit FE and the antenna ANT can be shortened, and therefore, signal attenuation and noise emission can be reduced.

In addition, signal transmission between the frontend IC and the controller is in a digitalized form, and accordingly, the antenna unit AU can be separated from the controller 2 at a sufficient distance. By arranging the analog frontend unit FE in a signal-chip IC, the frontend IC and the corresponding antenna ANTam can be put into a signal unit to further miniaturize the circuit. Consequently, multiple antennas ANTa1-ANTan can be placed closer to the corresponding ID tags.

As has been described above, the ID tag reader/writer has multiple antenna units AU1-AUn corresponding to ID tags IT1-ITn to be monitored, and a desired antenna unit associated with the target ID tag to be currently monitored is selected to perform radio communications with the target ID tag. In addition, each of the antenna units AU1-AUn includes an analog frontend unit FE structured by analog circuits including a modulator/demodulator, which unit is arranged close to the associated antenna ANT. With this arrangement, even if the antenna units are placed away from the controller 2, signal attenuation and noise emission can be reduced because of digital data transmission between the controller 2 and the antenna unit AU.

This reader/writer can be applied to read and write information from and in any type of radio frequency ID tag. For example, an ID tag can be attached to each of the books in a bookshelf, and antenna units can be placed at certain intervals near the books to perform radio communications with the ID tags. Each antenna unit can communicate with multiple ID tags within its communication range. The antenna units are also connected to the controller via digital transmission lines, which may be placed away from the antenna units. Even if the ID tags attached to the books are of different types using different carrier frequencies, information can be read from and written to the different types of ID tags using a single reader/writer by generating different clock frequencies based on a clock supplied from the controller.

The same applies to management of parts and accessories on or in a photocopier or a multi-function image reproducing apparatus. In this case, the antenna units can be placed at certain positions inside or outside the photocopier or the apparatus. Each of the antenna units can communication with multiple ID tags attached to the parts located within the communication range. The ID tags in the range may be of different types or the same type. In either case, the ID tag reader/writer can read and write information from and in the ID tags within the communication range of each antenna unit.

This patent application is based on and claims the benefit of the earlier filing date of Japanese Patent Application No. 2004-366280 filed Dec. 17, 2004, the entire contents of which are hereby incorporated by reference.

What is claimed is:

1. An ID tag reader/writer for writing and reading data in and from one or more ID tags, comprising:
one or more antennas configured to perform radio communication with the ID tags;
one or more analog frontend units, each unit being provided for one of the antennas, configured to generate a carrier wave based on a clock signal and to perform signal modulation and demodulation; and
a controller configure to generate and output the clock signal to the analog frontend units and select one of the analog frontend units corresponding to a target ID tag to which the data are to be transmitted,
wherein the controller performs data transmission to and from each of the analog frontend units using a digital signal line.

2. The ID tag reader/writer of claim 1, wherein each of the analog frontend units is integrated in a single chip integrated circuit.

3. The ID tag reader/writer of claim 1, wherein each of the antennas has a communication range and is configured to communicate with one or more of the ID tags located within the communication range using one or more clock frequencies generated by the associated analog frontend unit.

4. The ID tag reader/writer of claim 1, wherein each of the antennas and the associated analog frontend unit defines an antenna unit, and the antenna unit is arranged away from the controller.

5. The ID tag reader/writer of claim 4, wherein the antenna units are placed near the ID tags.

6. The ID tag reader/writer of claim 3, wherein each of the analog frontend units has a transmission clock generator configured to generate said different clock frequencies based on the clock supplied from the controller via the associated digital signal line.

7. The ID tag reader/writer of claim 1, wherein each of the analog frontend units is located near the associated antenna.

8. The ID tag reader/writer of claim 1,
wherein each of the analog frontend units has an address setting unit in which a prescribed address is allocated, and
wherein when receiving address data from the controller, the analog frontend unit compares the address data with the allocated address and perform data transmission with the controller if the address data agree with the allocated address.

9. The ID tag reader/writer of claim 8, wherein if the address data supplied from the controller agree with the allocated address, the analog frontend unit operates according to a command transmitted from the controller via the digital signal line.

10. The ID tag reader/writer of claim 9, wherein the controller supplies the address data for designating a desired one of the analog frontend units, together with tag identification information designating the target ID tag.

11. The ID tag reader/writer of claim 6, wherein each of the analog frontend units further has an analog frontend (AFE) control circuit configured to control an operation of the transmission clock generator according to a command supplied from the controller.
